(19) United States
(12) Patent Application Publication
(10) Pub. No.: US 2018/0270848 A1
(43) Pub. Date: Sep. 20, 2018

(54) Data transmission method, client device and serving end device

(71) Applicant: ZTE CORPORATION, Shenzhen (CN)

(72) Inventors: Chunli Liang, Shenzhen (CN); Bo Dai, Shenzhen (CN)

(21) Appl. No.: 15/743,046

(22) PCT Filed: Mar. 4, 2016
(86) PCT No.: PCT/CN2016/075659

§ 371 Date: Jan. 9, 2018

(30) Foreign Application Priority Data
Jul. 10, 2015 (CN) 201510408187.3

(51) Int. Cl. H04W 72/12; H04W 72/04; H04L 5/00

(52) U.S. Cl. CPC H04W 72/1268; H04W 72/0446; H04W 74/08; H04W 72/1289; H04L 5/0048

(57) ABSTRACT

A data transmission method, comprising: receiving first downlink control information related to uplink transmission; acquiring uplink and downlink transmission region indication information; according to the received first downlink control information and the acquired uplink and downlink transmission region indication information, conducting uplink transmission in an uplink transmission region of a sub-frame n; and conducting downlink reception in a downlink transmission of the sub-frame n, where n is an integer. By means of the solution, a pre-scheduled sub-frame for uplink transmission also comprises a downlink transmission region for downlink transmission. When downlink transmission needs to be conducted, a downlink service can be transmitted in time through the downlink transmission region. Based on the existing LTE frame, a low time delay data transmission solution is implemented, so that a service with a low time delay requirement can be satisfied.

### TECHNICAL FIELD

The disclosure relates to, but not limited to, the technical field of data transmission, and particularly to a data transmission method, client device and server device.

### BACKGROUND

In a Long Term Evolution (LTE) system, data transmission is performed in units of a subframe. A subframe of an LTE system takes 1 ms as a unit in a time domain, and 10 subframes form an LTE radio frame. A structure of an LTE radio frame is shown in FIG. 1.

Generally speaking, an LTE system includes three types of subframes respectively, i.e. a downlink subframe, an uplink subframe and a special subframe. They will be introduced below respectively.

For an existing downlink subframe structure, all time-frequency resources of a subframe are arranged for downlink transmission.

FIG. 2A, FIG. 2B and FIG. 2C show structure diagrams of an existing downlink subframe respectively.

As shown in FIG. 2A, the subframe is only configured with a Physical Downlink Control Channel (PDCCH), the first three Orthogonal Frequency Division Multiplexing (OFDM) symbols are arranged for the PDCCH, following OFDM symbols are arranged to send a Physical Downlink Shared Channel (PDSCH), and multiplexing of the PDCCH and the PDSCH is implemented in a time division manner. As shown in FIG. 2B, the subframe is configured with a PDCCH and an Enhanced PDCCH (EPDCCH), where the EPDCCH and a PDSCH occupy the same OFDM symbols, multiplexing is implemented in a frequency division manner, and multiplexing of the PDSCH and the PDCCH is implemented in the time division manner. As shown in FIG. 2C, the subframe is only configured with an EPDCCH, where the EPDCCH and a PDSCH occupy the same OFDM symbols, and multiplexing is implemented in the frequency division manner.

FIG. 3A, FIG. 3B and FIG. 3C show structure diagrams of an existing uplink subframe respectively. In uplink subframe structures in FIG. 3A, FIG. 3B and FIG. 3C, all time-frequency resources of subframes are arranged for uplink transmission.

As shown in FIG. 3A, FIG. 3A is a structure diagram of a subframe arranged to send a reference signal of a Physical Uplink Shared Channel (PUSCH), where a patterned OFDM symbol is the reference signal (patterned time-domain symbols in FIG. 3B and FIG. 3C are also reference signals). FIG. 3B and FIG. 3C are structure diagrams of a reference signal of a Physical Uplink Control Channel (PUCCH). There are multiple PUCCH formats in an existing protocol, where a PUCCH format 1/1a/1b adopts the structure diagram of the reference signal shown in FIG. 3B, and a PUCCH format 2/2a/2b/3 adopts the structure diagram of the reference signal shown in FIG. 3C.

Referring to FIG. 4, FIG. 4 is a structure diagram of a special subframe according to a conventional art. A special subframe set in a Time Division Duplex (TDD) system may be arranged for downlink transmission, and may also be arranged for uplink transmission, but uplink transmission in the special subframe only includes sending of a Sounding Reference Signal (SRS), and does not include sending of uplink service data. As shown in FIG. 4, the special subframe includes three special time slots: a Downlink Pilot Time Slot (DwPTS), a Guard Period (GP) and an Uplink Pilot Time Slot (UpPTS), where the DwPTS is arranged for downlink transmission, and downlink transmission includes transmission of a downlink control channel and a downlink service channel; the GP is configured as a GP for uplink and downlink switching; and the UpPTS may be arranged to send an SRS and a Physical Random Access Channel (PRACH), and the UpPTS may not send a PUCCH and a PUSCH.

LTE is a centralized control system, that is, both uplink and downlink transmission is controlled by a base station. For downlink transmission, control information and data related to downlink transmission is sent on the same subframe (called as intraframe scheduling). For uplink transmission, control information related to uplink transmission is required to be sent in advance, and the control information, sent on a subframe n, related to uplink transmission indicates uplink transmission on a subframe n+K. (called as advanced scheduling). In a Frequency Division Duplex (FDD) system, a value of K is 4, while in a TDD system, for different uplink and downlink proportions, K has different values on different downlink subframes, generally speaking, K>=4, and the details may be referred to descriptions in related protocols.

Since uplink transmission of an LTE system requires pre-scheduling, m continuous subframes may all be arranged for uplink transmission after the m uplink subframes are continuously scheduled, if an existing subframe structure is adopted, all of the m continuous subframes may not be arranged for downlink transmission, and at this moment, if there is a downlink transmission requirement, transmission may be performed only after the m subframes. Descriptions will be made below in combination with a specific example.

Referring to FIG. 5, FIG. 5 is a schematic diagram of advanced scheduling for uplink transmission. K is set to be 4, a base station sends uplink scheduling information (Downlink Control Information (DCI) related to uplink transmission) on subframes #0˜#3, and then a terminal may perform uplink transmission on subframes #4˜#7. According to an existing subframe structure, an uplink subframe may only perform uplink transmission, if the base station requires sending for downlink transmission on the subframe #4, there is no subframe resource available for sending because the subframe #4 is determined to be arranged for uplink transmission through the uplink scheduling information of the subframe #0, and since the next 3 continuous subframes are also scheduled for uplink transmission in advance, there may be a resource available for sending of the base station till a subframe #8. Under such a circumstance, a delay-sensitive downlink service is greatly influenced. Therefore, an existing data transmission method may not meet a low-delay requirement, and a service with the low-delay requirement may not be smoothly implemented.

### SUMMARY

The below is a summary about a theme described in the disclosure in detail. The summary is not intended to limit the scope of protection of the claims.

Embodiments of the disclosure disclose a data transmission method, client device and server device, which may meet a low-delay requirement of a service.

The embodiments of the disclosure disclose a data transmission method, which may include the following acts.

First DCI related to uplink transmission is received.

Uplink and downlink transmission region indication information is acquired.

According to the received first DCI and the acquired uplink and downlink transmission region indication information, uplink transmission is performed in an uplink transmission region of a subframe n, and downlink reception is performed in a downlink transmission region of the subframe n, where n is an integer.

Optionally, the subframe n may include the uplink transmission region arranged for uplink transmission and the downlink transmission region arranged for downlink reception; the uplink and downlink transmission region indication information may include: related information of the uplink transmission region and. related information of the downlink transmission region.

The act of acquiring the uplink and downlink transmission region indication information may include the following acts.

The related information of the uplink transmission region of the subframe n is acquired, and the related information of the downlink transmission region of the subframe n is acquired.

The act of performing uplink transmission in the uplink transmission region of the subframe n and performing downlink reception in the downlink transmission region of the subframe n according to the received first DCI and the acquired uplink and downlink transmission region indication information may include the following acts.

Uplink transmission is performed in the uplink transmission region of the subframe n according to the received first DCI and the acquired related information of the uplink transmission region.

Downlink reception is performed in the downlink transmission region of the subframe n according to the acquired related information of the downlink transmission region.

Optionally, the act of acquiring the related information of the uplink transmission region of the subframe n may be implemented by adopting one of the following manners.

Statically set related information of the uplink transmission region is acquired;

Semi-statically configured related information of the uplink transmission region is acquired according to received high-layer signaling.

Dynamically configured related information of the uplink transmission region is acquired according to received second DCI.

Optionally, the related information of the uplink transmission region may include at least one of the following contents:

a duration of the uplink transmission region in the subframe;

the duration and a position of the uplink transmission region in the subframe;

a proportion and the position of the uplink transmission region in the subframe;

the proportion of the uplink transmission region in the subframe; or

a structure of the uplink transmission region and downlink transmission region in the subframe.

Optionally, the act of acquiring the related information of the downlink transmission region of the subframe n may be implemented by adopting one of the following manners.

Statically set related information of the downlink transmission region is acquired.

Semi-statically configured related information of the downlink transmission region is acquired according to received high-layer signaling.

Dynamically configured related information of the downlink transmission region is acquired according to received third DCI.

The related information of the downlink transmission region is acquired according to the related information of the uplink transmission region.

Optionally, the related information of the downlink transmission region may include at least one of the following contents:

a duration of the downlink transmission region in the subframe;

the duration and a position of the downlink transmission region in the subframe;

a proportion and the position of the downlink transmission region in the subframe;

the proportion of the downlink transmission region in the subframe; or

the structure of the uplink transmission region and downlink transmission region in the subframe.

Optionally, the structure of the uplink transmission region and downlink transmission region in the subframe may include:

a composition of a downlink control region, downlink data region, uplink special region and uplink data region in the subframe, wherein the uplink special region may include at least one of an uplink control region, an SRS region or a random access region.

Optionally, the composition of the downlink control region, downlink data region, uplink special region and uplink data region in the subframe may include one of the following composition manners, where a sequence of each data region or control region in the subframe may be:

the downlink control region, the downlink data region and the uplink special region;

the downlink control region, the downlink data region, the uplink data region and the uplink special region;

the downlink control region, the downlink data region and the uplink data region;

the downlink control region and the uplink data region; and

the downlink control region, the uplink data region and the uplink special region.

Optionally, the uplink and downlink transmission region indication information may include: first sub-subframe indication information and second sub-subframe indication information.

The first sub-subframe indication information may be arranged to instruct division of each of one or more subframes in a radio frame into N sub-subframes, and the second sub-subframe indication information may be arranged to instruct, for each of the divided subframes, determination of N1 ones of the sub-subframes as an uplink transmission region arranged for uplink transmission and determination of N2 ones of the sub-subframes as a downlink transmission region arranged for downlink transmission, wherein N1+N2<=N.

The act of acquiring the uplink and downlink transmission region indication information may include the following acts.

The first sub-subframe indication information is acquired, and the second sub-subframe indication information is acquired.

The act of performing uplink transmission in the uplink transmission region of the subframe n and performing downlink reception in the downlink transmission region of the subframe n according to the received first DCI and the acquired uplink and downlink transmission region indication information may include the following acts.

Each of the one or more subframes in the radio frame is divided into the N sub-subframes according to the first sub-subframe indication information.

For each of the divided subframes, according to the corresponding second sub-subframe indication information, uplink transmission is performed on the N1 sub-subframes, and downlink reception is performed on the N2 sub-subframes.

Optionally, the first sub-subframe indication information may be acquired by adopting one of the following manners:

statically set first sub-subframe indication information is acquired;

semi-statically configured first sub-subframe indication information is acquired according to received high-layer signaling; and

dynamically configured first sub-subframe indication information is acquired according to received fifth DCI.

Optionally, the second sub-subframe indication information may be acquired by adopting one of the following manners:

statically set second sub-subframe indication information is acquired;

semi-statically configured second sub-subframe indication information is acquired according to received high-layer signaling; and

dynamically configured second sub-subframe indication information is acquired according to received sixth DCI.

The embodiments of the disclosure further disclose a data transmission method, which may include the following acts.

First DCI related to uplink transmission is sent.

Uplink transmission of a terminal is received in an uplink transmission region of a subframe n, where the subframe n may include the uplink transmission region arranged for uplink transmission and a downlink transmission region arranged for downlink transmission, where n is an integer.

Optionally, before the act of receiving uplink transmission of the terminal in the uplink transmission region of the subframe n, the method may further include the following acts.

Downlink transmission is performed in the downlink transmission region of the subframe n.

Optionally, before the act of receiving uplink transmission of the terminal in the uplink transmission region of the subframe n, the data transmission method may further include the following acts.

Uplink and downlink transmission region indication information is sent to the terminal, where the uplink and downlink transmission region indication information may include at least one of: related information of the uplink transmission region or related information of the downlink transmission region.

Optionally, the act of sending the uplink and downlink transmission region indication information to the terminal may include that:

the related information of the uplink transmission region is sent to the terminal through high-layer signaling; or,

the related information of the uplink transmission region is sent to the terminal through second DCI; or,

the related information of the downlink transmission region is sent to the terminal through high-layer signaling; or,

the related information of the downlink transmission region is sent to the terminal through third DCI.

Optionally,

the first DCI and the second DCI may be sent on different DCI formats; or,

the first DCI and the second DCI may be sent on a same DCI format.

Optionally,

when the first DCI and the second DCI are sent on the same DCI format,

a newly added control field may be set in the DCI format corresponding to the first DCI, and the second DCI may be sent on the newly added control field; or,

the second DCI may be sent by virtue of an existing control field in the DCI format.

Optionally,

when the related information of the downlink transmission region is sent to the terminal through the third DCI,

the third DCI and fourth DCI related to downlink transmission may be sent on different DCI formats; or,

the third DCI and the fourth DCI may be sent on the same DCI format.

Optionally,

when the third DCI and the fourth DCI are sent on the same DCI format,

a newly added control field may be set in the DCI format corresponding to the fourth DCI, and the third DCI may be sent on the newly added control field, or,

the third DCI may be sent by virtue of an existing control field in the DCI format.

Optionally, the second DCI and the third DCI may be sent on the same DCI format.

Optionally, the related information of the uplink transmission region may include at least one of the following contents:

a duration of the uplink transmission region in the subframe;

the duration and a position of the uplink transmission region in the subframe;

a proportion and the position of the uplink transmission region in the subframe;

the proportion of the uplink transmission region in the subframe; or

a structure of the uplink transmission region and downlink transmission region in the subframe.

Optionally, the related information of the downlink transmission region may include at least one of the following contents:

a duration of the downlink transmission region in the subframe;

the duration and a position of the downlink transmission region in the subframe;

a proportion and the position of the downlink transmission region in the subframe;

the proportion of the downlink transmission region in the subframe; or

the structure of the uplink transmission region and downlink transmission region in the subframe.

Optionally, before the act of receiving uplink transmission of the terminal in the uplink transmission region of the subframe n, the data transmission method may further include the following acts.

The uplink and downlink transmission region indication information is sent to the terminal, wherein the uplink and downlink transmission region indication information may include: first sub-subframe indication information and second sub-subframe indication information.

Where the first sub-subframe indication information may be arranged to instruct division of each of one or more subframes in a radio frame into N sub-subframes, and the second sub-subframe indication information may be arranged to instruct, for each of the divided subframes, determination of N1 ones of the sub-subframes as an uplink transmission region arranged for uplink transmission and determination of N2 ones of sub-subframes as a downlink transmission region arranged for downlink transmission, where N1+N2<=N.

Optionally, the act of sending the uplink and downlink transmission region indication information to the terminal may include that:

the first sub-subframe indication information is sent to the terminal through high-layer signaling; or,

the first sub-subframe indication information is sent to the terminal through fifth DCI; or,

the second sub-subframe indication information is sent to the terminal through high-layer signaling; or,

the second sub-subframe indication information is sent to the terminal through sixth DCI.

The embodiments of the disclosure further disclose client device, which may be arranged on a terminal, the client device including a first receiving unit, an uplink and downlink transmission region acquisition unit, and a first transmission unit.

The first receiving unit is arranged to receive first DCI related to uplink transmission.

The uplink and downlink transmission region acquisition unit is arranged to acquire uplink and downlink transmission region indication information.

The first transmission unit is arranged to, according to the received first DCI and the acquired uplink and downlink transmission region indication information, perform uplink transmission in an uplink transmission region of a subframe n and perform downlink reception in a downlink transmission region of the subframe n, where n is an integer.

Optionally, the subframe n may include the uplink transmission region arranged for uplink transmission and the downlink transmission region arranged for downlink reception; the uplink and downlink transmission region indication information may include: related information of the uplink transmission region and related information of the downlink transmission region.

The uplink and downlink transmission region acquisition unit may include an uplink transmission region acquisition module and a downlink transmission region acquisition module.

The uplink transmission region acquisition module is arranged to acquire the related information of the uplink transmission region of the subframe n.

The downlink transmission region acquisition module is arranged to acquire the related information of the downlink transmission region of the subframe n.

The first transmission unit may include a first downlink transmission module and a first uplink transmission module.

The first downlink transmission module is arranged to perform downlink reception in the downlink transmission region of the subframe n according to the acquired related information of the downlink transmission region.

The first uplink transmission module is arranged to perform uplink transmission in the uplink transmission region of the subframe n according to the received first DCI and the acquired related information of the uplink transmission region.

Optionally, the uplink transmission region acquisition module may include one or more of the following submodules: a first acquisition submodule, a second acquisition module and a third acquisition module.

The first acquisition submodule is arranged to acquire statically set related information of the uplink transmission region.

The second acquisition submodule is arranged to acquire semi-statically configured related information of the uplink transmission region according to received high-layer signaling.

The third acquisition submodule is arranged to acquire dynamically configured related information of the uplink transmission region according to received second DCI.

Optionally, the downlink transmission region acquisition module may include one or more of the following submodules: a fourth acquisition submodule, a fifth acquisition submodule, a sixth acquisition submodule, and a seventh acquisition submodule.

The fourth acquisition submodule is arranged to acquire statically set related information of the downlink transmission region.

The fifth acquisition submodule is arranged to acquire semi-statically configured related information of the downlink transmission region according to received high-layer signaling.

The sixth acquisition submodule is arranged to acquire dynamically configured related information of the downlink transmission region according to received third DCI.

The seventh acquisition submodule is arranged to acquire the related information of the downlink transmission region according to the related information of the uplink transmission region.

Optionally, the uplink and downlink transmission region indication information may include: first sub-subframe indication information and second sub-subframe indication information.

Where the first sub-subframe indication information may be arranged to instruct division of each of one or more subframes in a radio frame into N sub-subframes, and the second sub-subframe indication information may be arranged to instruct, for each of the divided subframes, determination of N1 ones of the sub-subframes as an uplink transmission region arranged for uplink transmission and determination of N2 ones of the sub-subframes as a downlink transmission region arranged for downlink transmission, where N1+N2<=N.

The uplink and downlink transmission region acquisition unit may include: a first sub-subframe acquisition module and a second sub-subframe acquisition module.

The first sub-subframe acquisition module is arranged to acquire the first sub-subframe indication information.

The second sub-subframe acquisition module is arranged to acquire the second sub-subframe indication information.

The first transmission unit may be arranged to: divide each of the one or more subframes in the radio frame into the N sub-subframes according to the first sub-subframe indication information, and for each of the divided subframes, according to the corresponding second sub-subframe indication information, perform uplink transmission on the N1 sub-subframes and perform downlink reception on the N2 sub-subframes.

Optionally, the first sub-subframe acquisition module may include at least one of the following submodules: a first sub-subframe acquisition submodule, a second sub-subframe acquisition submodule, or a third sub-frame acquisition submodule.

The first sub-subframe acquisition submodule is arranged to acquire statically set first sub-subframe indication information.

The second sub-subframe acquisition submodule is arranged to acquire semi-statically configured first sub-subframe indication information according to received high-layer signaling.

The third sub-subframe acquisition submodule is arranged to acquire dynamically configured first sub-subframe indication information according to received fifth DCI.

The second sub-subframe acquisition module may include at least one of the following submodules: a fourth sub-subframe acquisition submodule, a fifth sub-subframe acquisition submodule, or a sixth sub-subframe acquisition submodule.

The fourth sub-subframe acquisition submodule is arranged to acquire statically set second sub-subframe indication information.

The fifth sub-subframe acquisition submodule is arranged to acquire semi-statically configured second sub-subframe indication information according to received high-layer signaling.

The sixth sub-subframe acquisition submodule is arranged to acquire dynamically configured second sub-subframe indication information according to received sixth DCI.

The embodiments of the disclosure further disclose a server device, which may be arranged on a network side, the server device including: a first sending unit and a second transmission unit.

The first sending unit is arranged to send first DCI related to uplink transmission.

The second transmission unit is arranged to perform uplink transmission of a terminal in an uplink transmission region of a subframe n, wherein the subframe n may include the uplink transmission region arranged for uplink transmission and a downlink transmission region arranged for downlink transmission, where n is an integer.

Optionally, the second transmission unit may further be arranged to perform downlink transmission in the downlink transmission region of the subframe n.

Optionally,

the server device may further include: an uplink and downlink transmission region sending unit, arranged to send uplink and downlink transmission region indication information to the terminal, where the uplink and downlink transmission region sending unit may include at least one of the following modules: an uplink transmission region sending module or a downlink transmission region sending module.

The uplink transmission region sending module is arranged to send related information of the uplink transmission region.

The downlink transmission region sending module is arranged to send related information of the downlink transmission region.

The second transmission unit may include: a second downlink transmission module and a second uplink transmission module.

The second downlink transmission module is arranged to perform downlink sending in the downlink transmission region of the subframe n.

The second uplink transmission module is arranged to perform uplink reception in the uplink transmission region of the subframe n.

Optionally, the server device may further include: an uplink and downlink transmission region sending unit, arranged to send uplink and downlink transmission region indication information to the terminal, where the uplink and downlink transmission region sending unit may include the following modules: a first sub-subframe sending module and a second sub-subframe sending module.

The first sub-subframe sending module is arranged to send first sub-subframe indication information.

The second sub-subframe sending module is arranged to send second sub-subframe indication information.

The first sub-subframe indication information may be arranged to instruct division of each of one or more subframes in a radio frame into N sub-subframes, and the second sub-subframe indication information may be arranged to instruct, for each of the divided subframes, determination of N1 ones of the sub-subframes as an uplink transmission region arranged for uplink transmission and determination of N2 ones of the sub-subframes as a downlink transmission region arranged for downlink transmission, wherein N1+N2<=N.

The second transmission unit may be arranged to, according to the first sub-subframe indication information and the second sub-subframe indication information, perform uplink reception on the N1 sub-subframes and perform downlink sending on the N2 sub-subframes.

Optionally, the uplink transmission region sending module may include one or more of the following submodules: a first sending submodule and a second sending submodule.

The first sending submodule is arranged to send the related information of the uplink transmission region to the terminal through high-layer signaling.

The second sending submodule is arranged to send the related information of the uplink transmission region to the terminal through second DCI.

The downlink transmission region sending module may include one or more of the following submodules: a third sending submodule and a fourth sending submodule.

The third sending submodule is arranged to send the related information of the downlink transmission region to the terminal through high-layer signaling.

The fourth sending submodule is arranged to send the related information of the downlink transmission region to the terminal through third DCI.

Optionally, the first sub-subframe sending module may include one or more of the following submodules: a first sub-subframe sending submodule and a second sub-subframe sending submodule.

The first sub-subframe sending submodule is arranged to send the first sub-subframe indication information to the terminal through high-layer signaling.

The second sub-subframe sending submodule is arranged to send the first sub-subframe indication information to the terminal through fifth DCI.

The second sub-subframe sending module may include one or more of the following submodules: a third sub-subframe sending submodule and a fourth sub-subframe sending submodule.

The third sub-subframe sending submodule is arranged to send the second sub-subframe indication information to the terminal through high-layer signaling.

The fourth sub-subframe sending submodule is arranged to send the second sub-subframe indication information to the terminal through sixth DCI.

In addition, the embodiments of the disclosure further provide a computer-readable storage medium, which may store a computer-executable instruction, the computer-executable instruction being executed to implement a data transmission method applied to a client side.

In addition, the embodiments of the disclosure further provide a computer-readable storage medium, which may store a computer-executable instruction, the computer-executable instruction being executed to implement a data transmission method applied to a server side.

In addition, the embodiments of the disclosure further provide a subframe structure, which may include an uplink transmission region arranged to uplink transmission and a downlink transmission region arranged for downlink transmission.

The technical solutions provided by the embodiments of the disclosure include that: the first DCI related to uplink transmission is received; the uplink and downlink transmission region indication information is acquired; and according to the received first DCI and the acquired uplink and downlink transmission region indication information, uplink transmission is performed in the uplink transmission region of the subframe n, and downlink reception is performed in the downlink transmission region of the subframe n, wherein n is an integer. According to the solutions, a subframe pre-scheduled for uplink transmission further includes a downlink transmission region arranged for downlink transmission, and when downlink transmission is required, a downlink service may be timely transmitted through the downlink transmission region, so that a low-delay data transmission solution is implemented on the basis of an existing LTE framework, and a low-delay requirement of a service may be met.

After the drawings and detailed descriptions are read and understood, the other aspects may be comprehended.

### BRIEF DESCRIPTION OF DRAWINGS

The drawings in the embodiments of the disclosure will be described below. The drawings in the embodiments are adopted to further understand the disclosure and, together with the specification, explain the disclosure and not intended to limit the scope of protection of the disclosure.

FIG. 1 is a structure diagram of an LTE radio frame according to the conventional art.

FIG. 2A, FIG. 2B and FIG. 2C are structure diagrams of a downlink subframe according to the conventional art respectively.

FIG. 3A, FIG. 3B and FIG. 3C are structure diagrams of an uplink subframe according to the conventional art respectively.

FIG. 4 is a structure diagram of a special subframe according to the conventional art.

FIG. 5 is a schematic diagram of advanced scheduling for uplink transmission according to the conventional art.

FIG. 6 is a flowchart of a data transmission method according to an embodiment of the disclosure.

FIG. 7 is a schematic diagram of configuration of a DCI format X according to an embodiment of the disclosure.

FIG. 8 is another schematic diagram of configuration of a DCI format X according to an embodiment of the disclosure.

FIG. 9A, FIG. 9B and FIG. 9C are structure diagrams of an uplink subframe according to an embodiment of the disclosure respectively.

FIG. 10A, FIG. 10B and FIG. 10C are schematic diagrams of a downlink subframe according to an embodiment of the disclosure respectively.

FIG. 11 is a schematic diagram of an improved uplink subframe according to an embodiment of the disclosure.

FIG. 12 is a schematic diagram of sending a PUCCH and a PUSCH in an uplink transmission region in a time division manner according to an embodiment of the disclosure.

FIG. 13A˜FIG. 13L are structure diagrams of a subframe according to an embodiment of the disclosure respectively.

FIG. 14A is a structure diagram of a special uplink and downlink subframe according to an embodiment of the disclosure.

FIG. 14B is a schematic diagram of a design of a Multimedia Broadcast Single Frequency Network (MBSFN) subframe supporting uplink and downlink transmission according to an embodiment of the disclosure.

FIG. 15A is a structure diagram of a reference signal of an uplink service/control channel design according to an embodiment of the disclosure.

FIG. 15B is a schematic diagram of a reference signal with a symbol number of 1 according to an embodiment of the disclosure.

FIG. 15C is a schematic diagram of a reference signal with a symbol number of 2 according to an embodiment of the disclosure.

FIG. 16A and FIG. 16B are structure diagrams of a subframe including sub-subframes according to an embodiment of the disclosure respectively.

FIG. 17A is a schematic diagram of configuration of sub-subframes based on an existing radio frame according to an embodiment of the disclosure.

FIG. 17B is a schematic diagram of a bitmap according to an embodiment of the disclosure.

FIG. 18 is a flowchart of another data transmission method according to an embodiment of the disclosure.

FIG. 19A is a structure diagram of client device according to an embodiment of the disclosure.

FIG. 19B is a structure diagram of server device according to an embodiment of the disclosure.

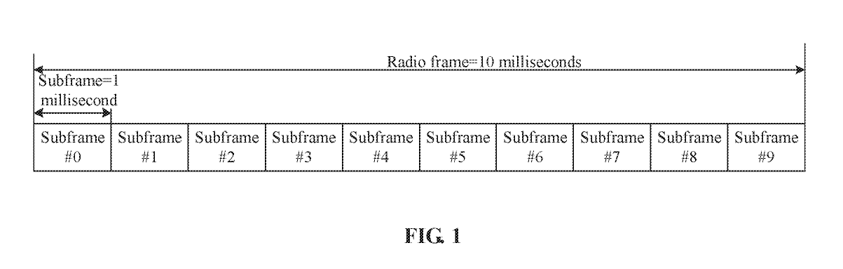

### DETAILED DESCRIPTION

For facilitating understanding of those skilled in the art, the disclosure will further be described below in combination with the drawings, and the scope of protection of the disclosure is not limited. It is important to note that the embodiments in the disclosure and various manners in the embodiments may be combined without conflicts.

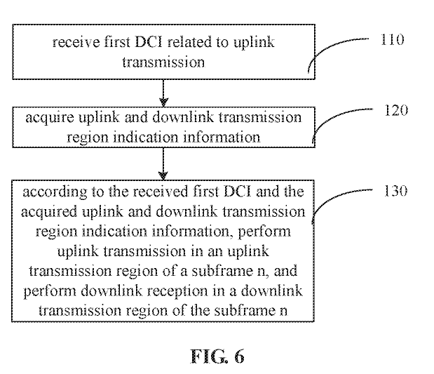

Referring to FIG. 6, an embodiment of the disclosure discloses a data transmission method. As shown in FIG. 6, the method includes the following steps.

In Step 110, first DCI related to uplink transmission is received.

The first DCI related to uplink transmission is uplink scheduling information. A terminal performs uplink transmission on a subframe n according to scheduling of the first DCI.

A base station may send the first DCI related to uplink transmission on a subframe n-K, wherein both n and K are integers.

K is contained in the DCI related to uplink transmission; or, K is a value predetermined by the base station and the terminal, and is only required to be specified in a protocol.

In Step 120, uplink and downlink transmission region indication information is acquired.

In an embodiment of the disclosure, the subframe n includes an uplink transmission region arranged for uplink transmission and a downlink transmission region arranged for downlink reception; and the uplink and downlink transmission region indication information includes: related information of the uplink transmission region and related information of the downlink transmission region.

The act of acquiring the uplink and downlink transmission region indication information in Step 120 may include the following acts.

In Step 121, the related information of the uplink transmission region of the subframe n is acquired.

In Step 122, the related information of the downlink transmission region of the subframe n is acquired.

The act of acquiring the related information of the uplink transmission region of the subframe n in Step 121 is implemented by adopting one of the following manners.

In a manner 1-1, statically set related information of the uplink transmission region is acquired;

In a manner 1-2, semi-statically configured related information of the uplink transmission region is acquired according to received high-layer signaling; and

in a manner 1-3, dynamically configured related information of the uplink transmission region is acquired according to received second DCI.

Exemplarily, if the related information of the uplink transmission region is semi-statically configured through the high-layer signaling, the related information of the uplink transmission region may be set in a data region such as a PDSCH, and if being contained through the second DCI, the related information of the uplink transmission region is set in a PDCCH.

In the manner 1-3, the related information of the uplink transmission region may specifically be transmitted by adopting two manners. The first is manner 1-3-1: formats of the first DCI and the second DCI adopt different DCI formats. The second is manner 1-3-2: the formats of the first DCI and the second DCI adopt a same DCI format. In the manner 1-3-2, the related information of the uplink transmission region is transmitted on the subframe n-K. In the manner 1-3-1, the first DCI related to uplink transmission may be transmitted on the subframe n-K, and the related information of the uplink transmission region is transmitted on the subframe n-K or a subframe before the subframe n-K.

In the manner 1-3-1, the DCI format corresponding to the second DCI is a DCI format X, the DCI format corresponding to the first DCI is an existing DCI format, a size of the DCI format X is the same as a size of the existing DCI format, and the DCI format X and the existing DCI format are scrambled through different Radio Network Temporary Identities (RNTIs) to make such a distinction that the DCI format X is arranged to indicate the related information of the uplink transmission region.

A subframe sending the DCI format X may be configured in a high-layer manner. One configuration manner is to configure a sending period of the DCI format X and a subframe offset in the period.

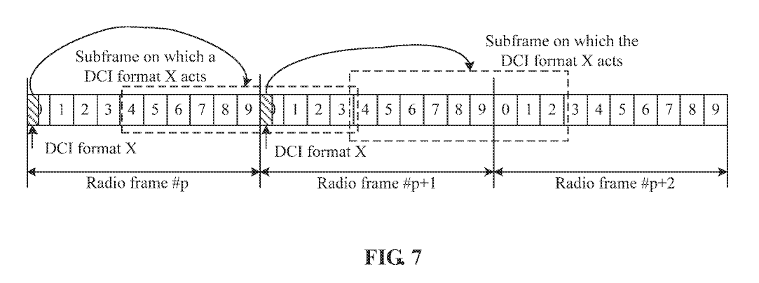

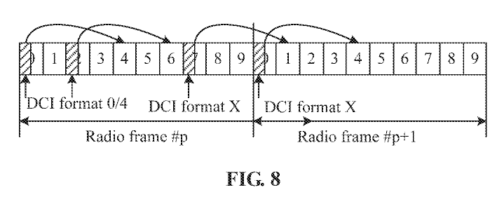

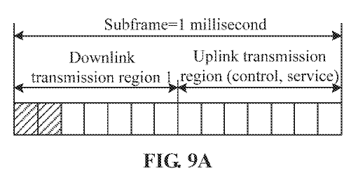

Referring to FIG. 7, FIG. 7 is a schematic diagram of configuration of a DCI format X according to an embodiment of the disclosure. As shown in FIG. 7, the sending period of the DCI format X is 10 milliseconds and the subframe offset is 0, so that the DCI format X is sent on a subframe #0 of each radio frame, the terminal acquires the related information of the uplink transmission region by demodulating the DCI format X, and the acquired related information of the uplink transmission region may be arranged for subframes #4˜#9 of a current radio frame #p and subframes #0˜#3 of a next radio frame #p+1.

In the manner 1-3-1, the sending period of the DCI format X may be configured according to a requirement of an uplink service, thereby dynamically regulating a transmission region arranged for uplink transmission in a subframe. Reasonably configuring the sending period of the DCI format X may achieve higher adaptability to a changing requirement of an uplink and downlink service, meanwhile, ensures timely sending of a downlink service and facilitates improvement of system performance.

In the manner 1-3-2, the first DCI and the second DCI are sent in the same DCI format 0/4. One manner is to add a new control field arranged to indicate the related information of the uplink transmission region in the DCI format 0/4, and the other manner is to reuse or redefine an existing control field in the DCI format 0/4, and one may be reuse or redefinition of a resource allocation indication field. By adopting such a manner, for each subframe for uplink transmission, its uplink transmission region may dynamically change, and such a manner may better achieve self-adaptability of an uplink service and make resources fully utilized. When the related information indicating the uplink transmission region is reuse of the existing control field, no additional signaling is required, but if it is adoption of the resource allocation indication field, resource allocation may be limited to a certain extent.

When the related information indicating the uplink transmission region and the first DCI related to uplink transmission are sent in the DCI format 0/4, the subframe on which the indication information acts is determined according to a Hybrid. Automatic Repeat reQuest (HARQ) timing relationship, and in a related system, the DCI sent on the subframe and related to uplink transmission may instruct the terminal to perform uplink transmission on the subframe n. FIG. 8 shows a corresponding schematic diagram. As shown in FIG. 8, when the base station sends the DCI format 0/4 on the subframe #0 of the radio frame #p, uplink transmission is indicated to be performed on the subframe #4 of the radio frame #p; and when the base station sends the DCI format 0/4 on the subframe #2 of the radio frame #p, uplink transmission is instructed to be performed on the subframe #6 of the radio frame #p.

In the embodiment of the disclosure, when there is uplink transmission to be sent on a subframe, the terminal performs uplink transmission according to the related information, indicated by the DCI format X, of the uplink transmission region; and there is no uplink transmission to be sent on the subframe, the terminal performs downlink reception according to a default manner.

The act of performing, by the terminal, downlink reception according to the default manner includes, but not limited to, the following manners.

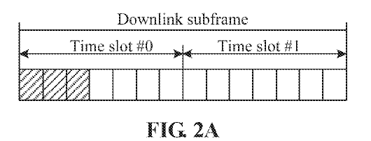

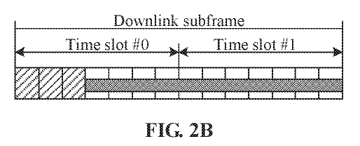

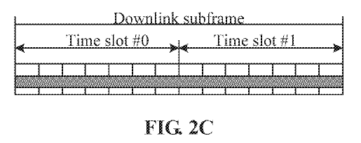

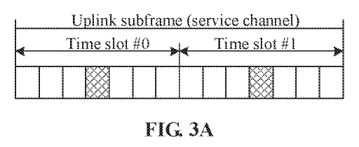

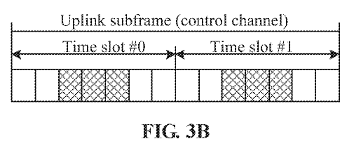

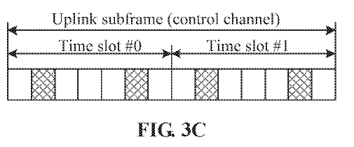

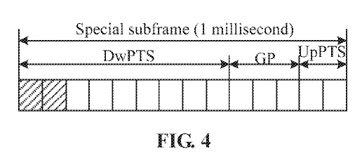

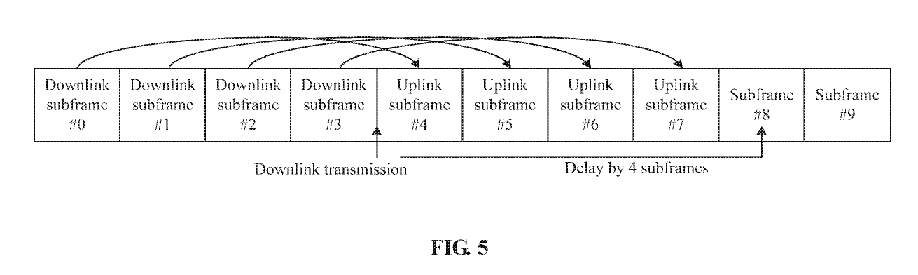

In a manner 3-1, the terminal performs reception according to a conventional downlink subframe, for example, FIG. 2A, FIG. 2B and FIG. 2C show structure diagrams of an existing downlink subframe respectively.

In a manner 3-2, the terminal performs reception according to an improved downlink subframe, the improved downlink subframe including a downlink transmission region and an uplink transmission region, where the uplink transmission region occupies last OFDM symbols of the subframe predetermined with the base station, and these OFDM symbols are arranged for sending of uplink control information or an SRS or a PRACH.

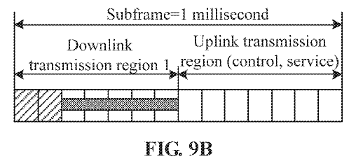

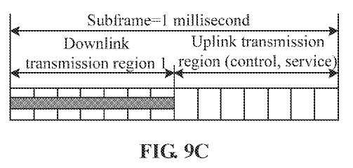

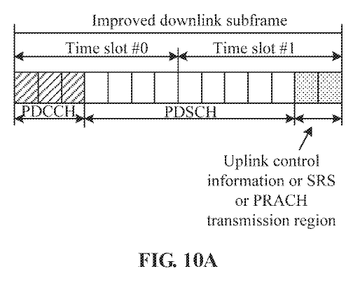

FIG. 9A, FIG. 9B and FIG. 9C are structure diagrams of an uplink subframe according to an embodiment of the disclosure respectively.

In a related protocol, the DCI related to uplink transmission includes the DCI format 0/4. If the terminal receives the DCI format 0 or 4 on the subframe n-K, the terminal may perform PUSCH transmission on the subframe n.

When performing PUSCH transmission on the subframe n, the terminal determines the uplink transmission region available for PUSCH transmission, where the uplink transmission region is determined according to an acquisition manner provided by the embodiment of the disclosure. Specific descriptions will be made below in combination with the drawings.

As shown in FIG. 9A, FIG. 9B and FIG. 9C, the subframe n includes two time slots, i.e. a time slot #0 and a time slot #1, wherein the time slot #0 is the downlink transmission region, and the time slot #1 is the uplink transmission region. The base station performs downlink transmission on the time slot #0 of the subframe n, the terminal may receive downlink transmission on the time slot #0 of the subframe n, the terminal may send uplink transmission on the time slot #1 of the subframe n, and the base station receives uplink transmission on the time slot #1 of the subframe n.

When the related information of the uplink transmission region is acquired by adopting the manner 1-1, as long as uplink transmission is to be performed on the subframe n, the related information of the uplink transmission region is fixed, so that a proportion and position of the uplink transmission region in the subframe are both fixed, the terminal may only perform uplink transmission in the fixed uplink transmission region, and when there is downlink transmission to be sent, the base station may perform downlink transmission in the corresponding downlink transmission region. Therefore, the problem of incapability in timely sending downlink transmission due to the fact that only uplink transmission may be performed on a subframe pre-scheduled for uplink transmission in the conventional art is solved. However, in such a manner, both the uplink transmission region and the downlink transmission region are fixed, there may exist the condition of poor adaptability to changes of uplink and downlink services, there may also exist a certain resource waste, and its advantage is that no additional signaling is required for indication.

The related information of the uplink transmission region may further be acquired by adopting the manner 1-2 or the manner 1-3, and in the two manners, the related information of the uplink transmission region may be specified, thereby flexibly setting a size of the uplink transmission region according to a requirement of the uplink service.

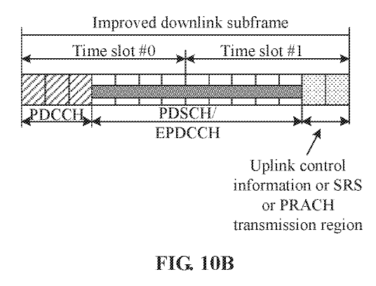

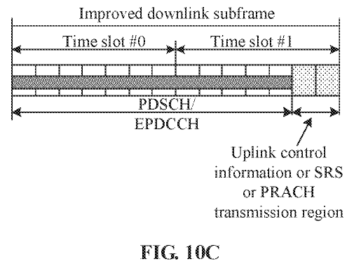

FIG. 10A, FIG. 10B and FIG. 10C are schematic diagrams of an improved downlink subframe according to an embodiment of the disclosure respectively. As shown in FIG. 10A, FIG. 10B and FIG. 10C, the last OFDM symbols of the subframe are reserved for sending the uplink control information or the SRS or the MACH, wherein a number of the reserved OFDM symbols is predetermined by the base station and the terminal, and 1˜2 OFDM symbols are preferred. Adopting the improved downlink subframe may ensure timely sending of the uplink control information and the SRS, and is beneficial to reduction in a delay and timely acquisition of channel state related information.

In the embodiment of the disclosure, another improved uplink subframe is further provided. The improved uplink subframe includes a downlink control region and an uplink transmission region, and the downlink control region is arranged to send necessary DCI.

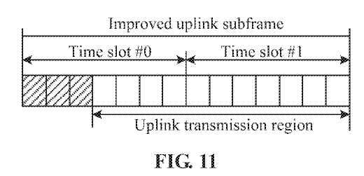

When there are more uplink services, the improved uplink subframe may be adopted for transmission of the uplink services. FIG. 11 is a schematic diagram of an improved uplink subframe according to an embodiment of the disclosure. By adopting such an improved uplink subframe structure, transmission of the uplink services may be ensured on one hand; and on the other hand, the downlink control region is reserved, so that timely sending of some necessary DCI is also ensured.

In the embodiment of the disclosure, the terminal performs uplink transmission in the uplink transmission region, and uplink transmission includes, but not limited to, at least one of transmission of a physical uplink channel or a physical uplink signal, wherein the physical uplink channel includes a PUSCH, a PUCCH and a PRACH, and the physical uplink signal includes an SRS.

In an existing system, whether to simultaneously send the PUCCH and the PUSCH on the same subframe or not may be configured through high-layer signaling, and when the two are arranged to be simultaneously sent, the PUCCH and the PUSCH are simultaneously transmitted in a frequency division manner.

When the terminal performs transmission in the uplink transmission region provided by the embodiment of the disclosure, whether to simultaneously send the PUCCH and the PUSCH or not may be configured through the high-layer signal, the two may also be supported to be simultaneously transmitted as a default or the two may not be supported to be simultaneously transmitted, and whether simultaneous transmission of the two is supported or not may further be dynamically indicated through DCI.

When the two are allowed to be simultaneously transmitted, simultaneous transmission of the PUCCH and the PUSCH may be implemented in the time division manner or in the frequency division manner. The frequency division manner is similar to the existing system, and will not be elaborated herein.

The PUCCH and the PUSCH are arranged to be sent in the uplink transmission region in the time division manner.

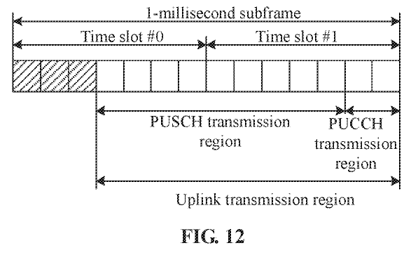

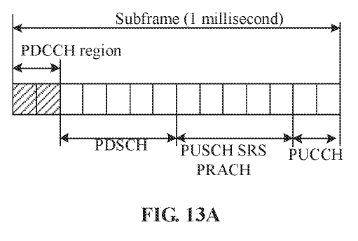

When the PUCCH and the PUSCH are sent in the uplink transmission region in the time division manner, a fixed PUCCH transmission region is reserved in the uplink transmission region, and the other uplink transmission region is determined as a PUSCH transmission region. FIG. 12 is a schematic diagram of sending a PUCCH and a PUSCH in an uplink transmission region in a time division manner.

When whether the PUCCH transmission region exists or not is indicated through physical DCI, the DCI indicating whether the PUCCH transmission region exists or not and the DCI indicating the uplink transmission region are sent on the same DCI format, and when sending the PUSCH, the terminal determines the PUSCH transmission region according to the indication information of the uplink transmission region and the indication information about whether the PUCCH transmission region exists or not. The DCI indicating whether the PUCCH transmission region exists or not may be indicated through 1 bit.

In the embodiment of the disclosure, the related information of the uplink transmission region includes at least one of the following contents:

a duration of the uplink transmission region in the subframe;

the duration and a position of the uplink transmission region in the subframe;

a proportion and the position of the uplink transmission region in the subframe;

the proportion of the uplink transmission region in the subframe; or

a structure of the uplink transmission region and downlink transmission region in the subframe.

The act of acquiring the related information of the downlink transmission region of the subframe in Step 122 is specifically implemented as follows: the related information of the downlink transmission region is acquired on a subframe before the subframe n.

In Step 130, according to the received first DCI and the acquired uplink and downlink transmission region indication information, uplink transmission is performed in an uplink transmission region of a subframe n, and downlink reception is performed in a downlink transmission region of the subframe n.

Step 130 may include the following steps.

In Step 131, downlink reception is performed in the downlink transmission region of the subframe n.

Downlink reception is performed in the downlink transmission region of the subframe n according to the acquired related information of the downlink transmission region. In addition, fourth DCI, i.e. downlink scheduling information, sent by the base station is further required to be acquired for downlink reception.

In Step 132, uplink transmission is performed in the uplink transmission region of the subframe n according to the received first DCI and the acquired related information of the uplink transmission region.

The act of acquiring the related information of the downlink transmission region of the subframe n in Step 122 is implemented by adopting one of the following manners.

In a manner 2-1, statically set related information of the downlink transmission region is acquired.

In a manner 2-2, semi-statically configured related information of the downlink transmission region is acquired according to received high-layer signaling.

In a manner 2-3, dynamically configured related information of the downlink transmission region is acquired according to received third DCI.

In a manner 2-4, the related information of the downlink transmission region is acquired according to the related information of the uplink transmission region.

In a manner 2-4, after the terminal acquires the related information of the uplink transmission region of the subframe n, the terminal actually obtains the related. information of the downlink transmission region of the subframe. This is because the related information of the uplink transmission region mainly refers to information on a time domain, and after the related information of the uplink transmission region is obtained, the other time in the subframe is arranged for downlink reception.

In the embodiment of the disclosure, the subframe n further includes an uplink and downlink conversion region, and the uplink and downlink conversion region is reserved in the downlink transmission region, or is reserved in the uplink transmission region, wherein, considering that the terminal may perform downlink reception as well as uplink transmission on the same subframe, there is necessarily a time for uplink and downlink conversion in the subframe.

In the manner 2-3, the related information of the downlink transmission region may specifically be transmitted by adopting two manners. The first is a manner 2-3-1: formats of the third DCI and the first DCI adopt different DCI formats. The second is a manner 2-3-2: the formats of the third DCI and the first DCI adopt the same DCI format.

For the manner 2-3-1, when the durations of the uplink transmission region and the downlink transmission region on the time domain and the positions in the subframe are contained through the same independent DCI format, the DCI indicating the duration of the uplink transmission region on the time domain and the position in the subframe and the DCI indicating the duration of the downlink transmission region on the time domain and the position in the subframe may share the same control field, for example, the shared control field indicates time proportion information of the two in the subframe, and meanwhile, it is predetermined that the downlink transmission region is at a front part of the subframe and the uplink transmission region is at a rear part of the subframe.

Optionally, the time proportion information is a ratio of numbers of OFDM symbols occupied by the uplink transmission region and the downlink transmission region, and optionally, the ratio includes, but not limited to, the following conditions:

when the subframe adopts a conventional cyclic prefix: the ratio of the numbers of the OFDM symbols occupied by the uplink transmission region and the downlink transmission region is any one of (12:2), (11:3), (10:4), (9:5), (7:7), (6:8), (3:11) and (2:12); and

when the subframe adopts an extended cyclic prefix: the ratio of the numbers of the OFDM symbols occupied by the uplink transmission region and the downlink transmission region is any one of (10:2), (9:3), (3:4), (6:6), (3:9) and (2:10).

Wherein, a GP for uplink and downlink switch may be implemented by removing a last symbol of the downlink transmission region, or is implemented by removing a first symbol of the uplink transmission region, which is only required to be predetermined by the terminal and the base station and will not be limited in the disclosure.

Particularly, when the GP for uplink and downlink switching is implemented by removing the first symbol of the uplink transmission region, the base station may refer to a design of a DwPTS in a special time slot in an existing TDD system when performing downlink transmission in the downlink transmission region.

In the embodiment of the disclosure, the related information of the downlink transmission region includes at least one of the following contents:

a duration of the downlink transmission region in the subframe;

the duration and a position of the downlink transmission region in the subframe;

a proportion and the position of the downlink transmission region in the subframe;

the proportion of the downlink transmission region in the subframe; or

the structure of the uplink transmission region and downlink transmission region in the subframe.

In the embodiment of the disclosure, the structure of the uplink transmission region and downlink transmission region in the subframe specifically includes:

a composition of a downlink control region, downlink data region, uplink special region and uplink data region in the subframe, wherein the uplink special region includes at least one of an uplink control region, an SRS region or a random access region.

In the embodiment of the disclosure, the composition of the downlink control region, downlink data region, uplink special region and uplink data region in the subframe includes one of the following combination manners, wherein a sequence of each data region or control region in the subframe is:

combination 1: the downlink control region, the downlink data region and the uplink special region;

combination 2: the downlink control region, the downlink data region, the uplink data region and the uplink special region;

combination 3: the downlink control region, the downlink data. region and the uplink data region;

combination 4: the downlink control region and the uplink data region; and

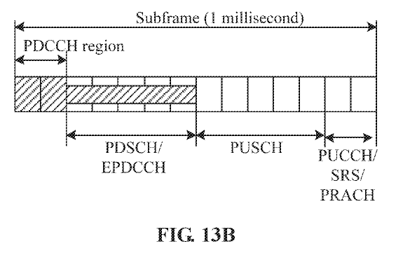

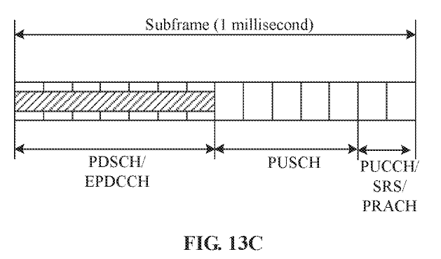

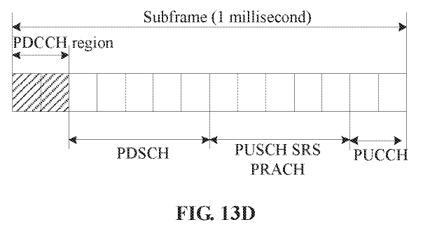

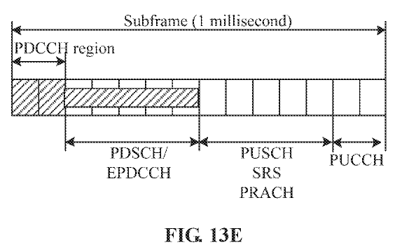

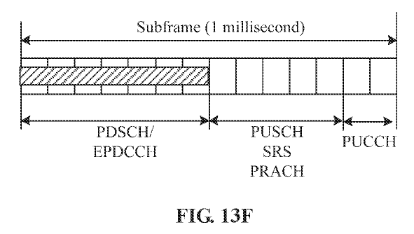

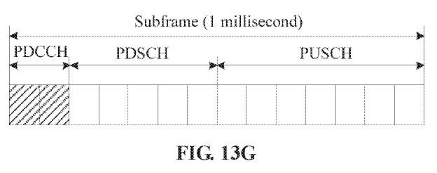

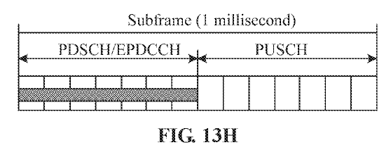

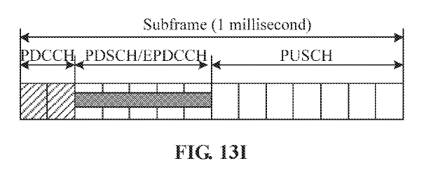

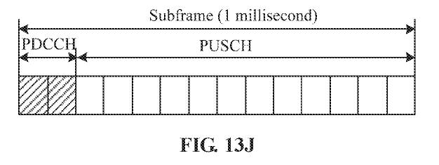

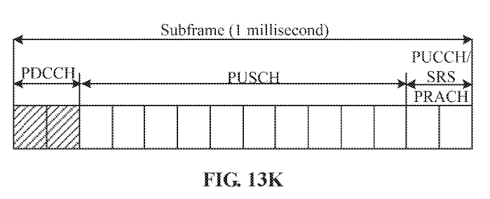

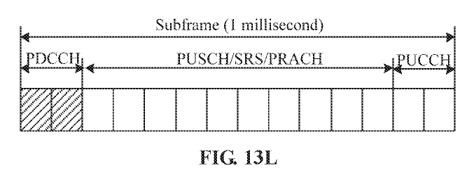

combination 5: the downlink control region, the uplink data region and the uplink special region.

Wherein, a specific example of combination 1 refers to FIG. 10A, FIG. 10B and FIG. 10C, wherein PUCCH, SRS and PRACH transmission may be performed in the uplink special region. A specific example of combination 2 refers to FIG. 13A, FIG. 13B, FIG. 13C, FIG. 13D, FIG. 13E and FIG. 13F, wherein PUSCH, SRS and PRACH transmission may be performed in the uplink data region, and PUCCH transmission may be performed in the uplink special region, or PUSCH transmission may be performed in the uplink data region, and PUCCH, SRS and PRAM transmission may be performed in the uplink special region. A specific example of combination 3 refers to FIG. 13G, FIG. 13H and FIG. 13I. A specific example of combination 4 refers to FIG. 13J. A specific example of combination 5 refers to FIG. 13K and FIG. 13L.

Descriptions will be made below in combination with a specific example.

In an example provided by the embodiment of the disclosure, for reducing influence on the existing system, special subframes in an existing TDD frame structure may be improved, and the improved special uplink and downlink subframes are utilized to implement uplink and downlink transmission.

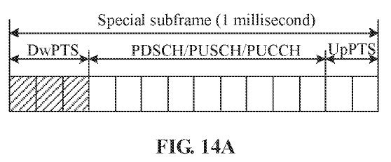

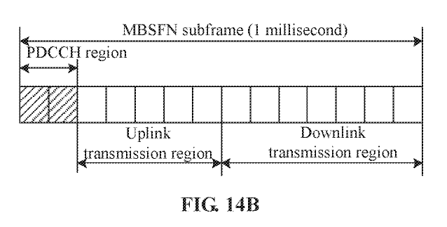

FIG. 14A is a structure diagram of a special uplink and downlink subframe. In the schematic diagram, a configuration that a DwPTS in a special subframe only includes 3 OFDM symbols, an UpPTS occupies 1 or 2 symbols, and the other symbols form a GP. In the embodiment of the disclosure, a GP in an original special subframe is utilized for PDSCH/PUSCH/PUCCH transmission, and optionally, an uplink transmission region and downlink transmission region in the GP may be fixed, or semi-statically configured or dynamically indicated by physical DCI.

For reducing the influence on the existing system, an MBSFN subframe in an existing frame structure may be utilized to implement uplink and downlink transmission. FIG. 14B is a schematic diagram of a design of an MBSFN subframe supporting uplink and downlink transmission. In the schematic diagram, first two symbols of the MBSFN subframe are arranged for PDCCH transmission, left symbols of a time slot 0 are arranged to uplink transmission, and a time slot is arranged for downlink transmission. Except the first two symbols arranged for PDCCH transmission in the MBSFN subframe, uplink transmission regions and downlink transmission regions in the other symbols may be fixed, or semi-statically configured or dynamically indicated by physical DCI. Specific implementation refers to the abovementioned embodiment.

In an example provided by the embodiment of the disclosure, a setting manner when the terminal performs uplink transmission in the uplink transmission region of the subframe is provided. Since there is no corresponding design in the existing system, it is necessary to consider a new design.

When the uplink transmission region includes 1 or 2 symbols after the GP is removed, the terminal sends an SRS or a PRACH on the 1 or 2 symbols, and sending of the SRS and sending of the PRACH may refer to a design of an UpPTS in a special time slot in an existing TDD system.

When the uplink transmission region includes 1 or 2 symbols after the GP is removed, the terminal may further send uplink control information on the 1 or 2 symbols, and the uplink control information is mainly a HARQ-Acknowledgement (HARQ-ACK), and is arranged to timely feed back downlink transmission. An existing PUCCH bearing uplink control information lasts for 1 subframe on the time domain, and when the uplink control information is only sent on 1˜2 symbols, a new design is required to be considered.

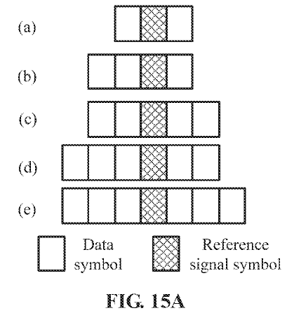

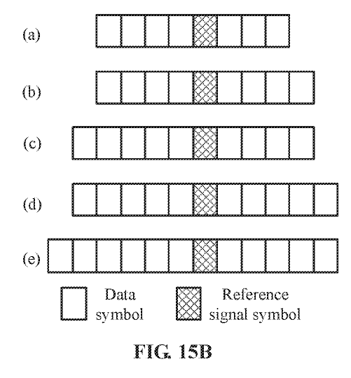

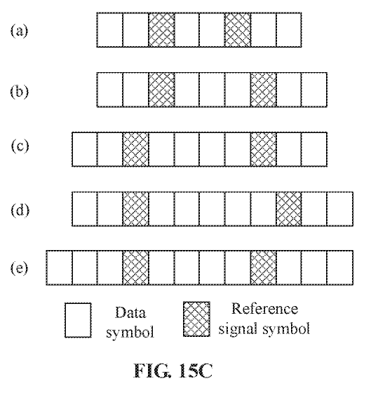

When the uplink transmission region (after the GP is removed) includes 3 to 7 symbols (an extended cyclic prefix includes 6), FIG. 15A is a structure diagram of a reference signal of an uplink service/control channel design. In FIG. 15A, the reference signal includes 1 symbol, and a data symbol is arranged to bear uplink service data or uplink control information, wherein a symbol number of the reference signal is set at a middle position of the data symbol.

When the uplink transmission region (after the GP is removed) includes 8 to 12 symbols (an extended cyclic prefix includes 7 to 10), FIG. 15B and FIG. 15C are structure diagrams of a reference signal of an uplink service/control channel design. The uplink transmission region does not support time slot frequency hopping, wherein FIG. 15B shows a schematic diagram of a reference signal with 1 symbol, FIG. 15C is a schematic diagram of a reference signal with 2 symbols, and a data symbol is arranged to bear uplink service data or uplink control information.

In another embodiment of the disclosure, the subframe is divided into multiple sub-subframes, and each sub-subframe includes an uplink transmission region and a downlink transmission region. Detailed descriptions will be made below.

In another embodiment of the disclosure, the uplink and downlink transmission region indication information includes: first sub-subframe indication information and second sub-subframe indication information, wherein the first sub-subframe indication information is arranged to instruct division of each of one or more subframes in a radio frame into N sub-subframes, and the second sub-subframe indication information is arranged to instruct, for each of the divided subframes, determination of N1 ones of the sub-subframes as an uplink transmission region arranged for uplink transmission and determination of N2 ones of the sub-subframes as a downlink transmission region arranged for downlink transmission, wherein N1+N2<=N.

The act of acquiring the uplink and downlink transmission region indication information in Step 120 includes the following steps.

In Step 125, the first sub-subframe indication information is acquired.

In Step 126, the second sub-subframe indication information is acquired.

The act of performing uplink transmission in the uplink transmission region of the subframe n and performing downlink reception in the downlink transmission region of the subframe n according to the received first DCI and the acquired uplink and downlink transmission region indication information in Step 130 includes the following acts.

Each of the one or more subframes in the radio frame is divided into the N sub-subframes according to the first sub-subframe indication information; and for each of the divided subframes, according to the corresponding second sub-subframe indication information, uplink transmission is performed on the N1 sub-subframes, and downlink reception is performed on the N2 sub-subframes.

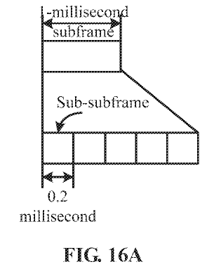

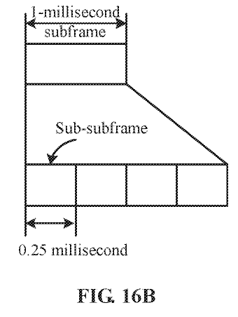

FIG. 16A and FIG. 16B are structure diagrams of a subframe including sub-subframes. A subframe of 1 millisecond is divided into 4 or 5 sub-subframes with smaller time lengths, a duration of each sub-subframe is 0.25 millisecond or 0.2 millisecond, and each sub-subframe may be arranged for at least one of uplink transmission or downlink transmission.

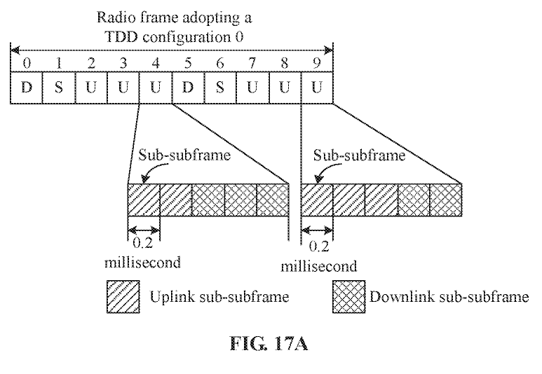

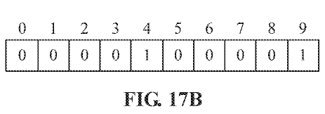

A sub-subframe is mainly designed for a low-delay service requirement. For compatibility with the existing system, one solution is to configure sub-subframes in one or more subframes in an existing radio frame and configure the other subframes for conventional service transmission. In such a manner, not only may a requirement of a conventional service be ensured, but also a requirement of a low-delay service may be ensured. FIG. 17A is a schematic diagram of configuration of sub-subframes of a radio frame based on an existing TDD uplink and downlink configuration 0. In the schematic diagram, an uplink subframe may be arranged to be formed by sub-subframes, for example, the subframe #4 and the subframe #9 may be arranged to be formed by 5 sub-subframes.

Wherein, the terminal acquires the first sub-subframe indication information by adopting one of the following manners.

Statically set first sub-subframe indication information is acquired;

Semi-statically configured first sub-subframe indication information is acquired according to received high-layer signaling; and

Dynamically configured first sub-subframe indication information is acquired according to received fifth DCI.

When semi-static configuration with the high-layer signaling or dynamic configuration with the fifth DCI is adopted, a bitmap including 10 bits may be adopted for indication, the bitmap including the 10 bits corresponds to 10 subframes in a radio frame, and when a corresponding bit in the bitmap is “1”, it is indicated that the subframe may be arranged to be formed by sub-subframes. FIG. 17B is a specific schematic diagram of a bitmap. In FIG. 17B, bits corresponding to the subframe 4 and the subframe 9 are arranged to be “1”, so that the subframe 4 and the subframe 9 are arranged to be formed by sub-subframes.

The terminal acquires the second sub-subframe indication information by adopting one of the following manners.

Statically set second sub-subframe indication information is acquired;

Semi-statically configured second sub-subframe indication information is acquired according to received high-layer signaling; and

Dynamically configured second sub-subframe indication information is acquired according to received sixth DCI.

When the second sub-subframe indication information is semi-statically configured by the high-layer signaling or is dynamically indicated by the sixth DCI is adopted, a bitmap including 5 bits may be adopted for indication, the bitmap including the 5 bits corresponds to 5 subframes in a radio frame, when a corresponding bit in the bitmap is “1”, it is indicated that the sub-subframe is arranged for uplink transmission, and when the corresponding bit in the bitmap is “0”, it is indicated that the sub-subframe is arranged for downlink transmission, wherein a size of the bitmap depends on a number of the sub-subframes into which the subframe is divided, and in the example, the subframe is divided into 5 sub-subframes.

In the embodiment of the disclosure, in the manner 1-1, optionally, the terminal determines the related information of the uplink transmission region corresponding to the terminal according to a cell. When the terminal enters a certain cell, the terminal acquires the related information of the uplink transmission region from the base station, and stores it in own storage unit, and when being required to configure the uplink transmission region of the subframe, the terminal acquires the stored related information of the uplink transmission region from the storage unit. Similarly, in manner 2-1, the related information of the downlink transmission region may be stored and acquired in the same manner. Similarly, for acquisition of the statically set first sub-subframe indication information and second sub-subframe indication information, the same manner may also be adopted for storage and acquisition.

In the embodiment of the disclosure, PUSCH, SRS and PRACH transmission may be performed in the uplink data region, and PUCCH transmission may be performed in the uplink special region, or, PUCCH transmission may be performed in the uplink data region, and PUCCH, SRS and PRACH transmission may be performed in the uplink special region.

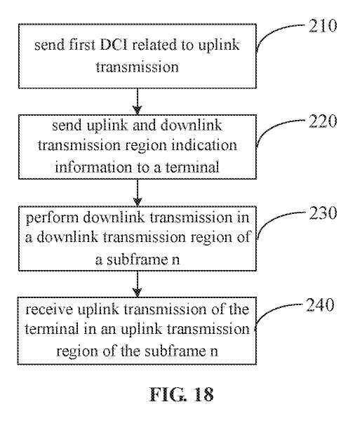

On the basis of a concept the same as or similar to the abovementioned method embodiment, an embodiment of the disclosure further provides another data transmission method. Referring to FIG. 18, the other data transmission method disclosed by the embodiment of the disclosure includes the following steps.

In Step 210, first DCI related to uplink transmission is sent.

Optionally, the first DCI related to uplink transmission is sent on a subframe n-K.

In Step 240, uplink transmission of a terminal is received in an uplink transmission region of a subframe n, where the subframe n includes the uplink transmission region arranged for uplink transmission and a downlink transmission region arranged for downlink transmission, where n and K are both integers.

Before Step 240, the method further includes Step 230: downlink transmission is performed in the downlink transmission region of the subframe n.

Wherein, before Step 230, the data transmission method further includes the following step.

In Step 220, uplink and downlink transmission region indication information is sent to the terminal.

In an exemplary embodiment of the disclosure, the uplink and downlink transmission region indication information includes at least one of related information of the uplink transmission region or related information of the downlink transmission region.

The act of sending the uplink and downlink transmission region indication information to the terminal in Step 220 includes the following steps.

In Step 221, the related information of the uplink transmission region is sent to the terminal.

In Step 222, the related information of the downlink transmission region is sent to the terminal.

A base station sends the related information of the uplink transmission region to the terminal through high-layer signaling; or, the base station sends the related information of the uplink transmission region to the terminal through second DCI.

In the embodiment of the disclosure, the base station sends the first DCI and the second DCI on different DCI formats; or, the base station sends the first DCI and the second DCI on the same DCI format.

When the first DCI and the second DCI are sent on the same DCI format, a newly added control field is set in the DCI format corresponding to the first DCI, and the second DCI is sent on the newly added control field; or, the second DCI is sent by virtue of an existing control field in the DCI format.

In the embodiment of the disclosure, the related information of the uplink transmission region includes at least one of the following contents:

a duration of the uplink transmission region in the subframe;

the duration and a position of the uplink transmission region in the subframe;

a proportion and the position of the uplink transmission region in the subframe;

the proportion of the uplink transmission region in the subframe; or

a structure of the uplink transmission region and downlink transmission region in the subframe.

A sequence of Step 221 and Step 222 may be changed, and in addition, the related information of the uplink transmission region and the related information of the downlink transmission region may also be simultaneously sent.

The base station sends the related information of the downlink transmission region to the terminal through high-layer signaling; or, the base station sends the related information of the downlink transmission region to the terminal through third DCI.

In the embodiment of the disclosure, when dynamically configured related information of the downlink transmission region is acquired according to the received third DCI, the base station sends the third DCI and fourth DCI related to downlink transmission on different DCI formats; or, the base station sends the third DCI and the fourth DCI on the same DCI format.

When the third DCI and the fourth DCI are sent on the same DCI format, a newly added control field is set in the DCI format corresponding to the fourth DCI, and the third DCI is sent on the newly added control field; or, the third DCI is sent by virtue of an existing control field in the DCI format.

In the embodiment of the disclosure, the base station may further be arranged to send the second DCI and the third DCI on the same DCI format.

In the embodiment of the disclosure, the related information of the downlink transmission region includes at least one of the following contents:

a duration of the downlink transmission region in the subframe;

the duration and a position of the downlink transmission region in the subframe;

a proportion and the position of the downlink transmission region in the subframe;

the proportion of the downlink transmission region in the subframe; or

the structure of the uplink transmission region and downlink transmission region in the subframe.

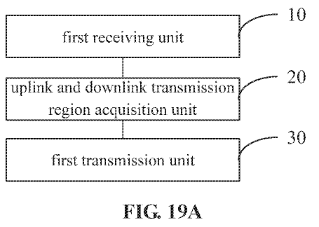

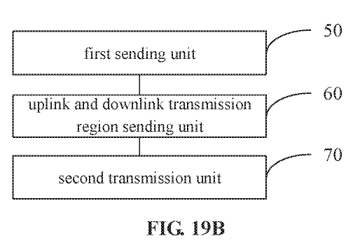

On the basis of a concept the same as or similar to the abovementioned method embodiment, an embodiment of the disclosure further provides client device, which is arranged on a terminal. Referring to FIG. 19A, the client device includes: a first receiving unit 10, an uplink and downlink transmission region acquisition unit 20 and a first transmission unit 30.

The first receiving unit 10 is arranged to receive first DCI related to uplink transmission.

The uplink and downlink transmission region acquisition unit 20 is arranged to acquire uplink and downlink transmission region indication information.

The first transmission unit 30 is arranged to, according to the received first DCI and the acquired uplink and downlink transmission region indication information, perform uplink transmission in an uplink transmission region of a subframe n and perform downlink reception in a downlink transmission region of the subframe n, wherein n is an integer.

In the embodiment of the disclosure, the subframe n includes the uplink transmission region arranged for uplink transmission and the downlink transmission region arranged for downlink reception; the uplink and downlink transmission region indication information includes: related information of the uplink transmission region and related information of the downlink transmission region.

The uplink and downlink transmission region acquisition unit 20 includes: an uplink transmission region acquisition module, and a downlink transmission region acquisition module.

The uplink transmission region acquisition module is arranged to acquire the related information of the uplink transmission region of the subframe n.

The downlink transmission region acquisition module is arranged to acquire the related information of the downlink transmission region of the subframe n.

The first transmission unit 30 includes: a first downlink transmission module and a first uplink transmission module.

The first downlink transmission module is arranged to perform downlink reception in the downlink transmission region of the subframe n according to the acquired related information of the downlink transmission region.

The first uplink transmission module is arranged to perform uplink transmission in the uplink transmission region of the subframe n according to the received first DCI and the acquired related information of the uplink transmission region.

In the embodiment of the disclosure, the uplink transmission region acquisition module includes one or more of the following submodules: a first acquisition submodule, a second acquisition submodule and a third acquisition submodule.

The first acquisition submodule is arranged to acquire statically set related information of the uplink transmission region.

The second acquisition submodule is arranged to acquire semi-statically configured related information of the uplink transmission region according to received high-layer signaling.

The third acquisition submodule is arranged to acquire dynamically configured related information of the uplink transmission region according to received second DCI.

In the embodiment of the disclosure, the downlink transmission region acquisition module includes one or more of the following submodules: a fourth acquisition submodule, a fifth acquisition submodule, a sixth acquisition submodule and a seventh acquisition submodule.

The fourth acquisition submodule is arranged to acquire statically set related information of the downlink transmission region.

The fifth acquisition submodule is arranged to acquire semi-statically configured related information of the downlink transmission region according to received high-layer signaling.

The sixth acquisition submodule is arranged to acquire dynamically configured related information of the downlink transmission region according to received third DCI.

The seventh acquisition submodule is arranged to acquire the related information of the downlink transmission region according to the related information of the uplink transmission region.

In the embodiment of the disclosure, the uplink and downlink transmission region indication information includes: first sub-subframe indication information and second sub-subframe indication information.

The first sub-subframe indication information is arranged to instruct division of each of one or more subframes in a radio frame into N sub-subframes, and the second sub-subframe indication information is arranged to instruct, for each of the divided subframes, determination of N1 ones of the sub-subframes as an uplink transmission region arranged for uplink transmission and determination of N2 ones of the sub-subframes as a downlink transmission region arranged for downlink transmission, wherein N1+N2<=N.

The uplink and downlink transmission region acquisition unit 20 includes: a first sub-subframe acquisition module and a second sub-subframe acquisition module.

The first sub-subframe acquisition module is arranged to acquire the first sub-subframe indication information.

The second sub-subframe acquisition module is arranged to acquire the second sub-subframe indication information.

The first transmission unit 30 is arranged to: divide each of the one or more subframes in the radio frame into the N sub-subframes according to the first sub-subframe indication information, and for each of the divided subframes, according to the corresponding second sub-subframe indication information, perform uplink transmission on the N1 sub-subframes and perform downlink reception on the N2 sub-subframes.

In the embodiment of the disclosure, the first sub-subframe acquisition module includes at least one of the following submodules: a first sub-subframe acquisition submodule, a second sub-subframe acquisition submodule or a third sub-subframe acquisition submodule.

The first sub-subframe acquisition submodule is arranged to acquire statically set first sub-subframe indication information.

The second sub-subframe acquisition submodule is arranged to acquire semi-statically configured first sub-subframe indication information according to received high-layer signaling.

The third sub-subframe acquisition submodule is arranged to acquire dynamically configured first sub-subframe indication information according to received fifth DCI.

the second sub-subframe acquisition module includes at least one of the following submodules: a fourth sub-subframe acquisition submodule, a fifth sub-subframe acquisition submodule, or a sixth sub-subframe acquisition submodule.

The fourth sub-subframe acquisition submodule is arranged to acquire statically set second sub-subframe indication information.

The fifth sub-subframe acquisition submodule is arranged to acquire semi-statically configured second sub-subframe indication information according to received high-layer signaling.

The sixth sub-subframe acquisition submodule is arranged to acquire dynamically configured second sub-subframe indication information according to received sixth DCI.

On the basis of a concept the same as or similar to the abovementioned embodiment, an embodiment of the disclosure further provides server device, which is arranged on a network side. FIG. 19B is a structure diagram of server device according to an embodiment of the disclosure. As shown in FIG. 19B, the server device includes: a first sending unit 50 and a second transmission unit 70.

The first sending unit 50 is arranged to send first DCI related to uplink transmission.

The second transmission unit 70 is arranged to perform uplink transmission of a terminal in an uplink transmission region of a subframe n, where the subframe n includes the uplink transmission region arranged for uplink transmission and a downlink transmission region arranged for downlink transmission, where n is an integer.

In the embodiment of the disclosure, the second transmission unit 70 is further arranged to perform downlink transmission in the downlink transmission region of the subframe n.

In the embodiment of the disclosure, the server device further includes:

an uplink and downlink transmission region sending unit 60, arranged to send uplink and downlink transmission region indication information to the terminal, where the uplink and downlink transmission region sending unit 60 includes at least one of the following modules: an uplink transmission region sending module or a downlink transmission region sending module.

The uplink transmission region sending module is arranged to send related information of the uplink transmission region.

The downlink transmission region sending module is arranged to send related information of the downlink transmission region.

The second transmission unit includes: a second downlink transmission module and a second uplink transmission module.

The second downlink transmission module is arranged to perform downlink sending in the downlink transmission region of the subframe n.

The second uplink transmission module is arranged to perform uplink reception in the uplink transmission region of the subframe n.

In another example in the embodiment of the disclosure, the uplink and downlink transmission region sending unit 60 includes the following modules: a first sub-subframe sending module and a second sub-subframe sending module.

The first sub-subframe sending module is arranged to send first sub-subframe indication information.

The second sub-subframe sending module is arranged to send second sub-subframe indication information.

The first sub-subframe indication information is arranged to instruct division of each of one or more subframes in a radio frame into N sub-subframes, and the second sub-subframe indication information is arranged to instruct, for each of the divided subframes, determination of N1 ones of the sub-subframes as an uplink transmission region arranged for uplink transmission and determination of N2 ones of the sub-subframes as a downlink transmission region arranged for downlink transmission, wherein N1+N2<=N.

The second transmission unit 70 is arranged to, according to the first sub-subframe indication information and the second sub-subframe indication information, perform uplink reception on the N1 sub-subframes and perform downlink sending on the N2 sub-subframes.

In the embodiment of the disclosure, the uplink transmission region sending module includes one or more of the following submodules: a first sending submodule and a second sending submodule.

The first sending submodule is arranged to send the related information of the uplink transmission region to the terminal through high-layer signaling.

The second sending submodule is arranged to send the related information of the uplink transmission region to the terminal through second DCI.

The downlink transmission region sending module includes one or more of the following submodules: a third sending submodule and a fourth sending submodule.

The third sending submodule is arranged to send the related information of the downlink transmission region to the terminal through high-layer signaling.

The fourth sending submodule is arranged to send the related information of the downlink transmission region to the terminal through third DCI.

In the embodiment of the disclosure, the first sub-subframe sending module includes one or more of the following submodules: a first sub-subframe sending submodule and a second sub-subframe sending submodule.

The first sub-subframe sending submodule is arranged to send the first sub-subframe indication information to the terminal through high-layer signaling.

The second sub-subframe sending submodule is arranged to send the first sub-subframe indication information to the terminal through fifth DCI.

The second sub-subframe sending module includes one or more of the following submodules: a third sub-subframe sending submodule, and a fourth sub-subframe sending submodule.

The third sub-subframe sending submodule is arranged to send the second sub-subframe indication information to the terminal through high-layer signaling.

The fourth sub-subframe sending submodule is arranged to send the second sub-subframe indication information to the terminal through sixth DCI.

In addition, an embodiment of the disclosure further provides a subframe structure, which includes: an uplink transmission region arranged for uplink transmission and a downlink transmission region arranged for downlink transmission. A specific content about the subframe structure is as mentioned in the abovementioned method embodiment, and thus will not be elaborated herein.

An embodiment of the disclosure further provides a computer-readable storage medium, which stores a computer-executable instruction, the computer-executable instruction being executed to implement a data transmission method applied to a client side.

An embodiment of the disclosure further provides a computer-readable storage medium, which may store a computer-executable instruction, the computer-executable instruction being executed to implement a data transmission method applied to a server side.

Those skilled in the art should understand that all or part of the steps in the methods may be implemented by instructing related hardware (for example, a processor) through a program, and the program may be stored in a computer-readable storage medium, for example, a read-only memory, a magnetic disk or an optical disk. Optionally, all or part of the steps of the abovementioned embodiments may further be implemented by virtue of one or more integrated circuits. Correspondingly, each module/unit in the abovementioned embodiments may be implemented in form of hardware, for example, a corresponding function is realized through an integrated circuit, and may further be implemented in form of software function module, for example, the corresponding function is realized by executing a program/instruction stored in a memory by the processor. The disclosure is not limited to a hardware and software combination in any specific form.

It is important to note that the abovementioned embodiments are adopted not to limit the scope of protection of the disclosure but only to facilitate understanding of those skilled in the art. Any apparent replacements, improvements and the like made by those skilled in the art without departing from the premise of the inventive concept of the disclosure shall fall within the scope of protection of the disclosure.

### INDUSTRIAL APPLICABILITY

The embodiments of the disclosure provide a data transmission method, client device and server device. A subframe pre-scheduled for uplink transmission further includes a downlink transmission region arranged for downlink transmission, and when downlink transmission is required, a downlink service may be timely transmitted through the downlink transmission region, so that a low-delay data transmission solution is implemented on the basis of an existing LTE framework, and a low-delay requirement of a service may be met.

1. A data transmission method, comprising:
receiving first Downlink Control Information (DCI) related to uplink transmission;
acquiring uplink and downlink transmission region indication information; and
according to the received first DCI and the acquired uplink and downlink transmission region indication information, performing uplink transmission in an uplink transmission region of a subframe n, and performing downlink reception in a downlink transmission region of the subframe n,
wherein n is an integer.

2. The data transmission method according to claim 1, wherein
the subframe n comprises the uplink transmission region arranged for uplink transmission and the downlink transmission region arranged for downlink reception; the uplink and downlink transmission region indication information comprises: related information of the uplink transmission region and related information of the downlink transmission region;
acquiring the uplink and downlink transmission region indication information comprises:
acquiring the related information of the uplink transmission region of the subframe n, and acquiring the related information of the downlink transmission region of the subframe n;
performing uplink transmission in the uplink transmission region of the subframe n and performing downlink reception in the downlink transmission region of the subframe n according to the received first DCI and the acquired uplink and downlink transmission region indication information, comprises:
performing uplink transmission in the uplink transmission region of the subframe n according to the received first DCI and the acquired related information of the uplink transmission region; and
performing downlink reception in the downlink transmission region of the subframe n according to the acquired related information of the downlink transmission region.

3. The data transmission method according to claim 2, wherein acquiring the related information of the uplink transmission region of the subframe n is implemented in one of the following manners:
acquiring statically set related. information of the uplink transmission region;
acquiring semi-statically configured related information of the uplink transmission region according to received high-layer signaling; and
acquiring dynamically configured related information of the uplink transmission region according to received second DCI,
wherein the related information of the uplink transmission region comprises at least one of the following contents:
a duration of the uplink transmission region in the subframe,
the duration and a position of the uplink transmission region in the subframe;
a proportion and the position of the uplink transmission region in the subframe;
the proportion of the uplink transmission region in the subframe; or
a structure of the uplink transmission region and downlink transmission region in the subframe.

4. (canceled)

5. The data transmission method according to claim 2, wherein acquiring the related information of the downlink transmission region of the subframe n is implemented by adopting one of the following manners:
acquiring statically set related information of the downlink transmission region;
acquiring semi-statically configured related information of the downlink transmission region according to received high-layer signaling;
acquiring dynamically configured related information of the downlink transmission region according to received third DCI; and
acquiring the related information of the downlink transmission region according to the related information of the uplink transmission region,
wherein the related information of the downlink transmission region comprises at least one of the following contents:
a duration of the downlink transmission region in the subframe;
the duration and a position of the downlink transmission region in the subframe;
a proportion and the position of the downlink transmission region in the subframe;
the proportion of the downlink transmission region in the subframe or
the structure of the uplink transmission region and downlink transmission region in the subframe.

6. (canceled)

7. The data transmission method according to claim 3, wherein the structure of the uplink transmission region and downlink transmission region in the subframe comprises:
a composition of a downlink control region, a downlink data region, an uplink special region and an uplink data region in the subframe, wherein the uplink special region comprises at least one of an uplink control region, an SRS region or a random access region,
wherein the composition of the downlink control region, the downlink data region, the uplink special region and the uplink data region in the subframe comprises one of the following composition manners, wherein a sequence of each data region or control region in the subframe is:
the downlink control region, the downlink data region and the uplink special region;
the downlink control region, the downlink data region the uplink data region and the uplink special region;
the downlink control region, the downlink data region and the uplink data region;
the downlink control region and the uplink data region; and
the downlink control region, the uplink data region and the uplink special region.

8. (canceled)

9. The data transmission method according to claim 1, wherein
the uplink and downlink transmission region indication information comprises: first sub-subframe indication information and second sub-subframe indication information,
wherein the first sub-subframe indication information is arranged to instruct division of each of one or more subframes in a radio frame into N sub-subframes, and the second sub-subframe indication information is arranged to instruct, for each of the divided subframes, determination of N1 ones of the sub-subframes as an uplink transmission region arranged for uplink transmission and determination of N2 ones of the sub-subframes as a downlink transmission region arranged for downlink transmission, wherein N1+N2<=N;
acquiring the uplink and downlink transmission region indication information comprises:
acquiring the first sub-subframe indication information, and acquiring the second sub-subframe indication information;
performing uplink transmission in the uplink transmission region of the subframe n and performing downlink reception in the downlink transmission region of the subframe n according to the received first DCI and the acquired uplink and downlink transmission region indication information comprises:
dividing each of the one or more subframes in the radio frame into the N sub-subframes according to the first sub-subframe indication information; and
for each of the divided subframes, according to the corresponding second sub-subframe indication information, performing uplink transmission on the N1 sub-subframes, and performing downlink reception on the N2 sub-subframes,
wherein the first sub-subframe indication information is acquired by adopting one of the following manners;
acquiring statically set first sub-subframe indication information;
acquiring semi-statically configured first sub-subframe indication information according to received high-layer signaling; and
acquiring dynamically configured first sub-subframe indication information according to received fifth DCI,
wherein the second sub-subframe indication information is acquired by adopting one of the following manners;
acquiring statically set second sub-subframe indication information;
acquiring semi-statically configured second sub-subframe indication information according to received high-layer signaling; and
acquiring dynamically configured second sub-subframe indication information according to received sixth DCI.

10-11. (canceled)

12. A data transmission method, comprising:
sending first Downlink Control Information (DCI) related to uplink transmission; and
receiving uplink transmission of a terminal in an uplink transmission region of a subframe n, wherein the subframe n comprises the uplink transmission region arranged for uplink transmission and a downlink transmission region arranged for downlink transmission,
wherein n is an integer.

13. The data transmission method according to claim 12, wherein before receiving uplink transmission of the terminal in the uplink transmission region of the subframe n, the method further comprises:
performing downlink transmission in the downlink transmission region of the subframe n.

14. The data transmission method according to claim 12, wherein before receiving uplink transmission of the terminal in the uplink transmission region of the subframe n, the method further comprises:
sending uplink and downlink transmission region indication information to the terminal, wherein the uplink and downlink transmission region indication information comprises at least one of: related information of the uplink transmission region or related information of the downlink transmission region.

15. The data transmission method according to claim 14, wherein sending the uplink and downlink transmission region indication information to the terminal comprises:
sending the related information of the uplink transmission region to the terminal through high-layer signaling; or,
sending the related information of the uplink transmission region to the terminal through second DCI; or,
sending the related information of the downlink transmission region to the terminal through high-layer signaling; or,
sending the related information of the downlink transmission region to the terminal through third DCI.

16. The data transmission method according to claim 15, wherein
the first DCI and the second DCI are sent on different DCI formats; or,
the first DCI and the second DCI are sent on a same DCI format,
wherein
when the first DCI and the second DCI are sent on the same DCI format
a newly added control field is set in the DCI format corresponding to the first DCI, and the second DCI is sent on the newly added control field; or,
the second DCI is sent by virtue of an existing control field in the DCI format,
wherein, when the related information of the downlink transmission region is sent to the terminal through the third DCI,
the third DCI and fourth DCI related to downlink transmission are sent on different DCI formats; or,
the third DCI and the fourth DCI are sent on a same DCI format,
wherein
when the third DCI and the fourth DCI are sent on the same DCI format,
a newly added control field is set in the DCI format corresponding to the fourth DCI, and the third DCI is sent on the newly added control field; or,
the third DCI is sent by virtue of an existing control field in the DCI format,
wherein
the second DCI and the third DCI are sent on a same DCI format.

17-20. (canceled)

21. The data transmission method according to claim 14, wherein the related information of the uplink transmission region comprises at least one of the following contents:
a duration of the uplink transmission region in the subframe;
the duration and a position of the uplink transmission region in the subframe;
a proportion and the position of the uplink transmission region in the subframe;
the proportion of the uplink transmission region in the subframe; or
a structure of the uplink transmission region and downlink transmission region in the subframe.

22. The data transmission method according to claim 14, wherein the related information of the downlink transmission region comprises at least one of the following contents:
a duration of the downlink transmission region in the subframe;
the duration and a position of the downlink transmission region in the subframe;
a proportion and the position of the downlink transmission region in the subframe;
the proportion of the downlink transmission region in the subframe; and
the structure of the uplink transmission region and downlink transmission region in the subframe.

23. The data transmission method according to claim 12, wherein before receiving uplink transmission of the terminal in the uplink transmission region of the subframe n, the method further comprises:
sending the uplink and downlink transmission region indication information to the terminal, wherein the uplink and downlink transmission region indication information comprises: first sub-subframe indication information and second sub-subframe indication information,
wherein the first sub-subframe indication information is arranged to instruct division of each of one or more subframes in a radio frame into N sub-subframes, and the second sub-subframe indication information is arranged to instruct, for each one of the divided subframes, determination of N1 ones of the sub-subframes as an uplink transmission region arranged for uplink transmission and determination of N2 ones of the sub-subframes as a downlink transmission region arranged for downlink transmission, wherein N1+N2<=N,
wherein sending the uplink and downlink transmission region indication information to the terminal comprises:
sending the first sub-subframe indication information to the terminal through high-layer signaling; or,
sending the first sub-subframe indication information to the terminal through fifth DCI; or,
sending the second sub-subframe indication information to the terminal through high-layer signaling: or,
sending the second sub-subframe indication information to the terminal through sixth DCI.

24-30. (canceled)

31. Server device, arranged on a network side, the server device comprising a processor and one or more units stored on a memory and executable by the processor, wherein the one or more units comprises:
a first sending unit, arranged to send first Downlink Control Information (DCI) related to uplink transmission; and
a second transmission unit, arranged to perform uplink transmission of a terminal in an uplink transmission region of a subframe n, wherein the subframe n comprises the uplink transmission region arranged for uplink transmission and a downlink transmission region arranged for downlink transmission, wherein n is an integer.

32. The server device according to claim 31, wherein the second transmission unit is further arranged to perform downlink transmission in the downlink transmission region of the subframe n.

33. The server device according to claim 32, wherein the one or more units further comprises:
an uplink and downlink transmission region sending unit, arranged to send uplink and downlink transmission region indication information to the terminal, wherein the uplink and downlink transmission region sending unit comprises at least one of the following modules:
an uplink transmission region sending module, arranged to send related information of the uplink transmission region, and
a downlink transmission region sending module, arranged to send related information of the downlink transmission region; and
the second transmission unit comprises:
a second downlink transmission module, arranged to perform downlink sending in the downlink transmission region of the subframe n, or
a second uplink transmission module, arranged to perform uplink reception in the uplink transmission region of the subframe n.

34. The server device according to claim 32, wherein the one or more units further comprises:
an uplink and downlink transmission region sending unit, arranged to send uplink and downlink transmission region indication information to the terminal, wherein the uplink and downlink transmission region sending unit comprises the following modules:
a first sub-subframe sending module, arranged to send first sub-subframe indication information, and
a second sub-subframe sending module, arranged to send second sub-subframe indication information,
wherein the first sub-subframe indication information is arranged to instruct division of each of one or more subframes in a radio frame into N sub-subframes, and the second sub-subframe indication information is arranged to instruct, for each of the divided subframes, determination of N1 ones of the sub-subframes as an uplink transmission region arranged for uplink transmission and determination of N2 ones of the sub-subframes as a downlink transmission region arranged for downlink transmission wherein N1+N2<=N; and
the second transmission unit is arranged to, according to the first sub-subframe indication information and the second sub-subframe indication information, perform uplink reception on the N1 sub-subframes and perform downlink sending on the N2 sub-subframes.

35. The server device according to claim 33, wherein
the uplink transmission region sending module comprises one or more of the following submodules:
a first sending submodule, arranged to send the related information of the uplink transmission region to the terminal through high-layer signaling, and
a second sending submodule, arranged to send the related information of the uplink transmission region to the terminal through second DCI; and
the downlink transmission region sending module comprises one or more of the following submodules:
a third sending submodule, arranged to send the related information of the downlink transmission region to the terminal through high-layer signaling, and
a fourth sending submodule, arranged to send the related information of the downlink transmission region to the terminal through third DCI.

36. The server device according to claim 34, wherein
the first sub-subframe sending module comprises one or more of the following submodules:
a first sub-subframe sending submodule, arranged to send the first sub-subframe indication information to the terminal through high-layer signaling, and
a second sub-subframe sending submodule, arranged to send the first sub-subframe indication information to the terminal through fifth DCI; and
the second sub-subframe sending module comprises one or more of the following submodules:
a third sub-subframe sending submodule arranged to send the second sub-subframe indication information to the terminal through high-layer signaling, and
a fourth sub-subframe sending submodule, arranged to send the second sub-subframe indication information to the terminal through sixth DCI.

37-38. (canceled)
